(19) United States
(12) Patent Application Publication
(10) Pub. No.: US 2006/0262702 A1
(43) Pub. Date: Nov. 23, 2006

(54) Optical pickup device

(76) Inventors: Tatsuro Ide, Kawasaki (JP); Takeshi Shimano, Yokohama (JP); Katsuhiko Kimura, Kasumigaura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/329,142

(22) Filed: Jan. 11, 2006

(30) Foreign Application Priority Data
May 18, 2005 (JP) 2005-144849

(51) Int. Cl. G11B 7/135

(52) U.S. Cl. 369/112.01

(57) ABSTRACT

The compatible type optical pickup device is capable of recording and reproducing optical disks in different disk substrate thickness such as BD and HD DVD or the like. In more detail, an optical pickup can record and reproduce the media of two or more kinds in different substrate thickness using almost identical wavelength or the identical laser source. One is provided as the infinite type optical system and the other is provided as the finite type optical system using an expander lens. Accordingly, the optical disks of different substrate thickness such as BD and HD DVD can be recorded and reproduced with compatibility using the identical wavelength of light.

### CLAIM OF PRIORITY

The present application claims priority from Japanese application JP 2005-144849 filed on May 18, 2005, the content of which is hereby incorporated by reference into this application.

### FIELD OF THE INVENTION

The present invention relates to a compatible type optical pickup device which is used for recording and reproducing various types of optical disks.

### BACKGROUND OF THE INVENTION

In recent years, optical disks are steadily progressing in higher recording density and a BD (Blu-ray Disc), ensuring recording capacity of 23 to 27 GB in single layer, which utilizes a blue-violet laser diode in the wavelength of about 405 nm was brought to market in 2003, in addition to the existing CD (recording capacity of about 0.78 GB) and the DVD (recording capacity of about 4.7 GB). Moreover, the HD DVD (recording capacity of 15 to 20 GB in single layer) which also utilizes a blue-violet laser diode in the wavelength of about 405 nm is also scheduled to be produced as a product up to 2005.

An optical pickup used for recording and reproducing optical disks records information by utilizing physical and chemical changes in the recording layers due to thermal effect of laser after condensing the light from a laser diode with an objective lens and then radiating the laser to an information recording surface through a transparent substrate of the optical disk, and reads information by utilizing change in the intensity of reflected light from the optical disk. At this time, in order to correctly condense the light from the laser diode onto a recording track located within the information recording surface of the optical disk, intensity of reflected light from the optical disk is detected as an electrical signal, focus error signal and tracking error signal are generated from this electrical signal, and position of the objective lens is controlled using these servo signals.

Recording capacity of optical disk is mainly determined with size of optical spot used for recording and reproducing of information. A size d of the optical spot when the light from a laser diode is condensed up to the diffraction limit with an objective lens is expressed with the following formula when wavelength of light is λ and numerical aperture of objective lens is NA and is inversely proportional to the wavelength λ and the numerical aperture of objective lens NA.
d=1.22λ/NA

For recording larger capacity information on an optical disk, shorter wavelength laser diode and higher NA of objective lens has been applied. The wavelength λ of laser diode used as the laser source is respectively about 780 nm, 660 nm, and 405 nm in CD, DVD, and BD (and HD DVD). On the other hand, a numerical aperture NA of objective lens is respectively about 0.45, 0.60, 0.65, and 0.85 in CD, DVD, HD DVD and BD.

In design of optical pickup, aberration in the whole optical system including aberration of an objective lens, aberration caused by the tilt of optical disk, and aberration of each optical component such as a mirror must be taken into consideration. In general, it is assumed that sufficiently condensed spot can be attained when RMS (Root Mean Square) wave front aberration of the entire optical system of optical pickup can be restrained to the value lower than 0.07 λrms which is called the Marechal's criteria.

Comatic aberration W₃₁ generated due to tilt of disk is proportional to raised 3^{rd} power of numerical aperture NA of objective lens and thickness t of disk substrate as expressed with the following formula 1, when thickness of disk substrate is t, refractive index of substrate is n, tilt of disk for pickup is θ, and numerical aperture of objective lens is NA.

$${W}_{31} = - \frac{t}{2} \frac{{n}^{2} ( {n}^{2} - 1 ) sin θ cos θ}{{( {n}^{2} - {sin}^{2} θ )}^{5 / 2}} {( NA )}^{3} \qquad ( formula 1 )$$

By the application of an objective lens having a higher numerical aperture NA for realization of high density recording of an optical disk, comatic aberration resulting from tilt of disk increases as the above formula indicates and thereby reproducing performance of pickup is remarkably lowered. Therefore, thickness t of disk substrate is sequentially reduced to BD from CD and DVD (and HD DVD) in order to acquire margin for tilt of disk. Thickness t of disk is specified such as 1.2 mm for CD, 0.6 mm for DVD, 0.6 mm for HD DVD, and 0.1 mm for BD. As an optical disk apparatus, compatibility for recording and reproducing of optical disks is strongly requested. At present, a compatible optical disk apparatus corresponding to recording and reproducing of all DVDs/CDs optical disks including DVD-RAM and a double-layer disk of DVD-R/+R is spreading in the market and development of the compatible optical disk apparatus corresponding to BD and HD DVD is expected in future.

Therefore, it is desirable that only one pickup and only one objective lens can be used for above mentioned various optical disks. When two or more optical systems are used simultaneously and objective lenses are switched depending on the kind of optical disk, the pickup itself becomes large in size and optical system/mechanism is complicated. “Only one objective lens” expressed above means that the objective lens is not switched depending on the kind of optical disk. Therefore, for example, a lens combining two lens (so-called a two-group-structured lens) may be used.

In the case when the light condensed with an objective lens in an optical pickup passes through a transparent substrate of disk having the refractive index n, spherical aberration W₄₀ as expressed with the following formula 2 is generated. This spherical aberration W₄₀ is proportional to substrate thickness t and raised 4^{th} power of numerical aperture NA.

$${W}_{40} = \frac{t}{8} \frac{{n}^{2} - 1}{{n}^{3}} {( NA )}^{4} \qquad ( formula 2 )$$

An objective lens of optical pickup is designed to cancel the spherical aberration generated when the light passes the disk substrate. However, when one objective lens is used for above mentioned various optical disks with one optical pickup, since amount of spherical aberration generated with different substrate thickness of each disk is also different in accordance with disk, if the objective lens is designed in optimum for a certain disk, the spherical aberration is left for the other disk, disabling sufficient condensation of an optical spot. Accordingly, the spherical aberration due to difference in substrate thickness must be compensated in view of ensuring compatibility of one objective lens for above mentioned various optical disks in different substrate thickness.

A method utilizing diffraction has been proposed to compensate for spherical aberration due to difference in substrate thickness. For example, as a method for ensuring compatibility of DVD and CD, a method has been proposed, in which diffracting function is additionally provided to an objective lens by providing a diffracting structure of ring belt to the surface of an objective lens and spherical aberration due to difference in disk substrate thickness can be compensated by utilizing difference in order of diffraction and difference in wavelength of light used for recording and reproducing of a disk in the DVD and CD. JP-A No. 1997-179020, corresponding U.S. Pat. No. 5,838,496, describes a technology for focusing on the information recording surface of respective disks by forming a diffraction pattern on the ring belt around an optical axis to one side of the surface of objective lens and dividing the light into a plurality focal points utilizing difference in order of diffraction using the identical wavelength. Meanwhile, JP-A No. 2000-81566, corresponding U.S. Pat. No. 6,118,594, describes a technology for forming excellent spot to respective disks by utilizing difference in wavelength with the diffraction light beam of the identical order of diffraction due to the light beam of two wavelengths. According to this technology, it is no longer required to divide the light to be used for recording and reproducing into two or more diffraction light beams having higher diffraction efficiency and higher optical efficiency can be obtained by blazing the diffraction surface. As a reason, this technology is widely used as a lens which is compatible for both DVD and CD.

On the other hand, in a finite type optical system to which a diverging light or a converging light is incident to an objective lens, if so-called objective lens shift is generated, in which an objective lens is shifted in the radial direction of an optical disk due to tracking, comatic aberration is generated and thereby aberration characteristic is deteriorated because a light flux is diagonally incident to the objective lens. Therefore, JP-A No. 2004-14095, corresponding U.S. Pat. No. 2004032815A1, describes a method in which when the objective lens shift occurs, the objective lens is simultaneously tilted in the radius direction of an optical disk in order to compensate for comatic aberration.

### SUMMARY OF THE INVENTION

In JP-A No. 1997-179020, optical efficiency cannot be improved because the lights used in the identical wavelength is divided at least into two or more diffraction lights.

Meanwhile, JP-A No. 2000-81566 cannot be adapted to two or more kinds of medium, for example to BD and HD DVD, using the identical wavelength because difference of wavelengths is utilized there.

JP-A No. 2004-14095 describes a compatible pickup using different wavelength for each type of respective media and is not compatible to two or more kinds of medium using the identical wavelength.

As explained above, the related arts do not disclose the technology which ensures compatibility only one pickup (or in only one optical path) for recording and reproducing of two or more kinds of medium (for example, BD and HD DVD) using the lights of the identical wavelength.

In order to solve the problems explained above, in the present invention, one is used for infinite type optical system and the other is used for finite type optical system in the optical pickup for recording and reproducing two or more kinds of medium in different substrate thickness using almost identical wavelength or identical laser source. Accordingly, even if the wavelength used for recording and reproducing is almost identical, recording and reproducing can be realized to two or more kinds of medium having different substrate thickness.

In more detail, according to one aspect of the present invention, a compatible type optical pickup comprises a laser source, an objective lens for condensing a light flux emitted from the laser source on an information recording surface of an optical disk, an optical beam splitter for separating the reflected light from the optical disk from the light path up to the optical disk from the laser source, an optical detector for detecting intensity of the reflected light from the beam splitter, a servo circuit for outputting focus error signal and tracking error signal by conducting the predetermined arithmetic operations to the signal outputted from the optical detector, and an actuator for driving the objective lens in the focus direction and/or tracking direction of the optical disk based on servo signal from a servo circuit. Moreover, the objective lens is designed to provide the best aberration characteristic as the infinite type optical system for the BD which requires highest NA and to compensate for spherical aberration due to difference in substrate thickness as the finite type optical system in which magnification is changed for the other optical disks.

Here, it is recommended, since disk substrate thickness is difference in BD and HD DVD, to provide an expander lens between the laser source and the objective lens in order to compensate for spherical aberration due to difference in substrate thickness. The magnification of the objective lens is switched in accordance with BD and HD DVD. Switching of magnification of the objective lens may be realized also by using a liquid crystal element. As explained above, in the optical pickup for recording or reproducing above mentioned various optical disks, spherical aberration generated because of difference in substrate thickness can be compensated by changing magnification of optical system in accordance with a disk.

Subsequently, compensation for comatic aberration will be explained. When an optical system is assumed as the finite type optical system, and when shift of an objective lens occurs in the radial direction of a medium, a large comatic aberration is generated. Therefore, it is enough that comatic aberration generated due to lens shift is compensated by providing moreover a mechanism to tilt the objective lens in the radial direction of optical disk to the actuator, tilting the objective lens in the radial direction of optical disk corresponding to shift of the objective lens in the radial direction of optical disk during the tracking operation, particularly for the optical disk other than the BD in the finite type optical system.

Here, amount of tilt of the objective lens is controlled in accordance with amount of shift of the objective lens. In more concrete, it is desirable that amount of tilt is almost proportional to amount of shift of the objective lens. Amount of tilt can also be controlled, for example, in accordance with drive current of the actuator for driving the objective lens in the radial direction of optical disk. Otherwise, amount of shift of the objective lens is detected in direct with a lens position detector and the tilt which is almost proportional to the detected amount of shift is added to the objective lens.

Moreover, it is desirable that amount of tilt of the objective lens is controlled to compensate for comatic aberration generated due to shift of the objective lens in accordance with the optical disk for recording and reproducing signals in an optical pickup device. Namely, amount of tilt of the objective lens for compensating for comatic aberration generated due to the shift of objective lens may be different in each disk for the above mentioned various optical disks.

In more concrete, the objective lens can be tilted in proportional to amount of shift of the objective lens and amount of lens tilt can be varied by providing, to the actuator, a first tracking coil and a second tracking coil along the focus direction as the optical axis direction of the objective lens and then changing a ratio of drive current to the first tracking coil and drive current to the second tracking coil.

As explained above, excellent aberration characteristic can be maintained respectively for above mentioned various optical disks by tilting the objective lens in the radial direction of optical disk together with shift thereof to cancel comatic aberration generated when the objective lens is shifted in the finite type optical system.

Subsequently, aperture stop of an objective lens will be explained. An objective lens is assumed here to have the largest numerical aperture among the numerical apertures required for optical disk for recording and reproducing. Therefore, the numerical apertures is switched by providing an aperture stop filter between a laser source and an objective lens so that only the light of the required numerical apertures is condensed on the information recording surface of an optical disk corresponding to the numerical apertures of objective lens other than the numerical apertures explained above.

For the BD and HD DVD, the lights of identical wavelength are used. But, since the numerical apertures of the objective lens required is different, a mechanism is provided, in which the kind of disk is distinguished when the disk is inserted and aperture stop is effective only for the HD DVD which requires a relatively small numerical apertures. In more concrete, a liquid crystal element which is controlled to vary a refractive index with an application voltage is allocated between a laser source and an objective lens. The liquid crystal element includes a first region having numerical aperture required for recording and reproducing of BD and a second region which is relatively smaller than the first region having numerical aperture required for recording and reproducing of HD DVD. At the time of recording and reproducing of the HD DVD, the refractive index of the first region is varied by applying a voltage to the liquid crystal element and the numerical aperture is switched by not allowing an optical flux incident to the first region to be transmitted.

Moreover, details of objective lens will then be explained. The infinite type optical system is provided for the BD, while the finite type optical system for the other disks. However, if the numerical apertures NA of objective lens is large and an absolute value of magnification is also large in the finite type optical system, comatic aberration due to shift of objective lens increases rapidly. A magnification β2 for the HD DVD desirably satisfies the condition (1) in order to keep the good aberration.
−0.080<β2<0 (1)

In the present invention, an objective lens is tilted to compensate for comatic aberration generated when the objective lens is shifted in the finite type optical system. However, if amount of tilt required for compensation is large, an interval between the objective lens and optical disk (working distance) becomes small, resulting in possibility for occurrence of collision between the objective lens and optical disk. Therefore, it is desirable that amount of tilt is reduced as much as possible. When curvature of the first surface of objective lens located in the side of laser source is c1 and curvature of the second surface located in the side of optical disk is c2, it is desirable that the following condition (2) is satisfied.
c1>c2>0 (2)

Moreover, in the present invention, the objective lens is tilted in the radius direction of optical disk in accompaniment with shift of lens and therefore an interval between the objective lens and optical disk is reduced because of lens tilt. Accordingly, it is desirable that edge thickness of objective lens is formed in the shape which makes difficult collision between the objective lens and the optical disk.

The objective lens is desirable to be formed to show excellent aberration performance for BD, HD DVD, DVD, and CD respectively. Namely, the first surface is formed to satisfy the following conditions (3)
0.55<c<0.65,
0≦A,B<1.0E−3,
−3.0E−4<C≦0,
0≦D,E<1.0E−4,
−2.0E−6<F,G,H,J<2.0E−6, (3)
while the second surface is formed to satisfy the following conditions (4)
0<c<0.1,
0≦A<5.0E−2,
−3.0E−2<B≦0,
0≦C<2.0E−2,
−3.0E−3<D≦0,
0≦E<3.0E−4,
−5.0E−5<F,G,H,J<5.0E−5. (4)

However, c is curvature of non-spherical surface on the optical axis, and A to J are non-spherical surface coefficients of the even degrees up to 20^{th} from 4^{th} degrees. Accordingly, amount of lens tilt required for compensation of comatic aberration generated due to lens shift can be restrained to 2° or less within the lens shift of 0.4 mm.

The present invention can realize an optical pickup which is compatible for optical disks in different substrate thickness such as BD, HD DVD, DVD, and CD or the like and is simplified in its optical system using only one objective lens.

### BRIEF DESCRIPTION OF THE DRAWINGS

FIG. 1 is a schematic structural diagram illustrating a first embodiment of a compatible type optical pickup device of the present invention.

FIG. 2 is a top view illustrating an example of a first aperture stop filter in the compatible type optical pickup device of the present invention.

FIG. 3 is a diagram illustrating an example of layout of a first and a second aperture stop filters in the compatible type optical pickup device of the present invention.

FIG. 4 is a top view illustrating an example of the second aperture stop filter in the compatible type optical pickup device of the present invention.

FIG. 5 is a perspective view illustrating an example of an actuator in the compatible type optical pickup device of the present invention.

FIG. 6 is a block diagram illustrating tracking drive and tilt drive of an objective lens in the compatible type optical pickup device of the present invention.

FIGS. 7A to 7D are diagrams illustrating an objective lens and an optical disk in the compatible type optical pickup device of the present invention. FIG. 7A is a light beam diagram in a first optical disk. FIG. 7B is a light beam diagram in a second optical disk. FIG. 7C is a light beam diagram in a third optical disk. FIG. 7D is a light beam diagram in a fourth optical disk.

FIGS. 8A to 8C are graphs illustrating amount of various aberrations generated for lens shift in the case where comatic aberration due to lens tilt is not compensated in the compatible type optical pickup device of the present invention. FIG. 8A is a graph illustrating amount of various aberrations generated in the second optical disk. FIG. 8B is a graph illustrating amount of various aberrations generated in the third optical disk. FIG. 8C is a graph illustrating amount of various aberrations generated in the fourth optical disk.

FIGS. 9A to 9C are graphs illustrating amount of various aberrations generated for lens shift when comatic aberration due to lens tilt is compensated and amount of lens tilt required for compensation in the compatible type optical pickup device of the present invention. FIG. 9A is a graph illustrating amount of various aberrations generated in the second optical disk and amount of lens tile required for compensation. FIG. 9B is a graph illustrating amount various aberrations generated in the third optical disk and amount of lens tilt required for compensation. FIG. 9C is a graph illustrating amount of various aberrations in the fourth optical disk and amount of lens tilt required for compensation.

FIG. 10 is a diagram illustrating definition in amount of lens tilt of an objective lens in the compatible type optical pickup device of the present invention.

FIG. 11 is a conceptual diagram illustrating lens tilt of the objective lens in the compatible type optical pickup device of the present invention.

FIG. 12 is a diagram illustrating an example of the objective lens in the compatible type optical pickup device of the present invention.

FIG. 13 is a schematic structural diagram illustrating a second embodiment of the compatible type optical pickup device of the present invention.

FIG. 14 is a schematic structural diagram illustrating a third embodiment of the compatible type optical pickup device of the present invention.

FIG. 15 is a schematic structural diagram illustrating a fourth embodiment of the compatible type optical pickup device of the present invention.

FIG. 16 is a schematic structural diagram illustrating a fifth embodiment of the compatible type optical pickup device of the present invention.

FIG. 17 is a schematic structural diagram illustrating a sixth embodiment of the compatible type optical pickup device of the present invention.

FIG. 18 is a diagram illustrating an example of a lens position detecting means for the objective lens in the compatible type optical pickup device of the present invention.

### DETAILED DESCRIPTION OF THE PREFERRED EMBODIMENTS

The preferred embodiments of the present invention will be explained in detail with reference to the accompanying drawings.

### First Embodiment

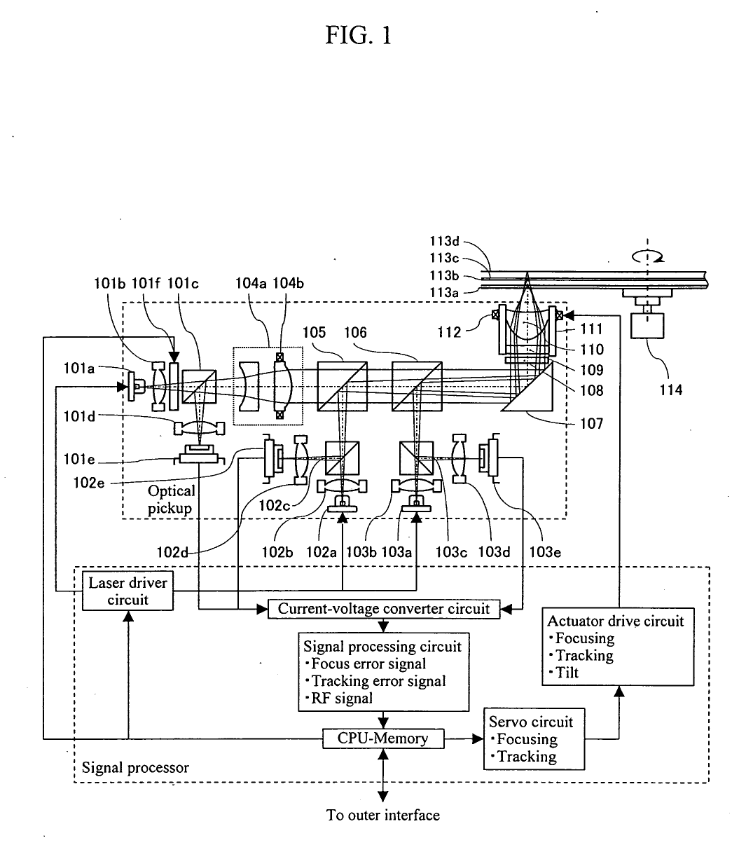

FIG. 1 is a diagram illustrating a total structure of an example of an optical pickup device as a first embodiment of the present invention. In the first embodiment, a structure of an optical pickup device provided with a laser diode of three different wavelengths as a laser source is illustrated. An optical pickup circuit comprises a laser diode 101a for a first wavelength, a laser diode 102a for a second wavelength, a laser diode 103a for a third wavelength, optical detectors 101e, 102e, 103e as the detecting means for the lights of respective wavelengths, coupling lenses 101b, 102b, 103b, optical beam splitters 101c, 102c, 103c, detecting lenses 101d, 102d, 103d, a first aperture stop filter 101f, an expander lens 104a for converting magnification from the first laser source 101a, an optical beam splitter 105 for combining or splitting the light from the first laser source 101a and the light from the second laser source 102a, an optical beam splitter 106 for combining or splitting the lights from the first and second laser sources 101a, 102a and the light from the third laser source 103a, a mirror 107, a ¼ λwavelength plate 108, a second aperture stop filter 109, an objective lens 110, an objective lens holder 111, and an objective lens actuator 112. 113a, 113b, 113c, 113d respectively denote a first, a second, a third, and a fourth optical disk. These optical disks 113a, 113b, 113c, 113d are rotated with a spindle motor 114. The first and second optical disks 113a, 113b execute recording and reproducing of signals using the light from the first laser source 101a, while the third optical disk 113c also execute recording and reproducing of signals using the light from the second laser source 102a, and the fourth optical disk, using the light from the third laser source 103a.

FIG. 1 also includes a diagram of light beam from each laser source at the time of recording and reproducing the first, third, and fourth optical disks. For example, in the recording and reproducing operations of the first optical disk, the light emitted from the first laser source 101a passes through the coupling lens 101b, first aperture stop filter 101f, optical beam splitter 101c, expander lens 104a and light beam splitters 105, 106 and is then focused on the information recording surface of the first optical disk 113a through the mirror 107, ¼ λwavelength plate 108, second aperture stop filter 109 and objective lens 110. The light reflected by the optical disk 113a goes inversely the descending optical path which is almost identical to the ascending path through the objective lens 107, optical beam splitters 106, 105. This returning light is reflected with the optical beam splitter 101c and is then focused to the optical detector 101e with the detecting lens 101d. The recording and reproducing operations of the second, third and fourth optical disks are also similar to that explained above and therefore additional explanation will be omitted here.

A signal processor is constituted with a current-voltage converter circuit for converting optical currents from the optical detectors 101e, 102e and 103e into voltages, a signal processing circuit for outputting a focus error signal, a tracking error signal and a reproduced RF signal, a servo circuit for compensating for focus error and tracking error, an actuator drive circuit for displacing the objective lens on the basis of a servo signal from the servo circuit, a CPU, a memory and a laser drive circuit. The CPU determines an optical disk for recording and reproducing of signals on the basis of the signal obtained from the signal processing circuit.

When the numerical apertures of the objective lens required for recording and reproducing of the first, second, third, and fourth optical disks are respectively assumed as NA1, NA2, NA3, and NA4, these NAs are also assumed to satisfy the following conditions (5).
NA1>NA2>NA4,NA1>NA3>NA4 (5)

Moreover, the wavelengths λ1, λ2, λ3 of the first, second, and third laser sources are also assumed to satisfy the following conditions (6).
λ1<λ2<λ3 (6)

Moreover, the substrate thickness t1, t2, t3, and t4 of the first, second, third, and fourth optical disks is also assumed to satisfy the following conditions (7).
t1<t2<t4,t1<t3<t4 (7)

The expander lens 104a is an optical element for switching divergence or convergence of light flux from the first laser source 101a in accordance with the first and second optical disks. Since the substrate thickness of disk is different as indicated by the conditions (7) in accordance with the first and second optical disks, spherical aberration generated must be compensated in accordance with the substrate. The expander lens 104 is formed of a pair of concave lens and convex lens. In the embodiment illustrated in FIG. 1, the convex lens is shifted in the optical axis direction with the actuator 104b. Accordingly, an interval of a pair of lenses can be varied and spherical aberration generated in the disk substrate can be compensated at the respective disks by adjusting the interval of a pair of lenses. In this case, since the numerical apertures NA1 required for recording and reproducing of the first optical disk is relatively larger than the numerical apertures NA2 required for recording and reproducing of the second optical disk as indicated by the conditions (5), comatic aberration generated due to objective lens shift becomes very large when the light incident to the objective lens 110 is the diverging light or the converging light. Therefore, the light flux emitted from the expander lens 104a should desirably be almost the parallel light for the recording and reproducing of the first optical disk. In this embodiment, the convex lens is shifted with the actuator but it may also be shifted with the concave lens. In addition, the expander lens formed of a set of concave lens and convex lens is used as the magnification converting means in this embodiment, but it is also possible to use the magnification converting means utilizing a liquid crystal element.

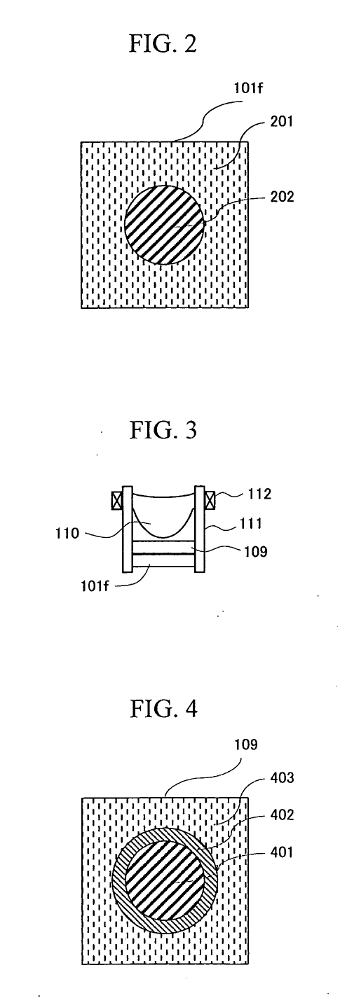

The first aperture stop filter 101f is an optical element for adjusting a size of numerical aperture for the light emitted from the first laser source. The first and second optical disks use the lights from the identical laser source 101a, but the numerical apertures NA of the objective lens required for recording and reproducing of the first optical disk is relatively larger than that for the second optical disk as indicated by the conditions (5). FIG. 2 is a top view illustrating an example of the first aperture stop filter 101f. The first aperture stop filter 101f is constituted with a first region 201 and a second region 202 to determine the type of optical disk for recording and reproducing operations. In the case of the first optical disk, the first aperture stop filter 101f passes the light flux which is incident thereto and in the case of the second optical disk, the filter 101f passes only the light flux which is incident to the second region 202 for the purpose of switching the numerical apertures. The first aperture stop filter 101f is a liquid crystal element which is controlled to vary a refractive index in accordance, for example, with an application voltage. This element is capable of switching the numerical apertures by varying the refractive index of the first region through application of voltage to the liquid crystal element for the recording and reproducing operations of the second optical disk and by not allowing the light flux incident to the first region 201 to pass the same region. It is also possible for the first aperture stop filter 101f to hold, as illustrated in FIG. 3, the objective lens holder 111 together with the objective lens and to be driven together with the objective lens with the actuator 112.

The second aperture stop filter 109 is an optical element for adjusting the numerical apertures in accordance with the wavelength of the incident light. With consideration from the conditions (5), the second aperture stop filter 109 has a large numerical aperture for the light of the first wavelength and a numerical aperture, which is relatively smaller than that for the light of the second wavelength, for the light of the third wavelength. FIG. 4 is a top view illustrating an example of the second aperture stop filter 109. The second aperture stop filter 109 is constituted with a region 401 for passing the light irrespective of the wavelengths of the incident light, a region 402 for passing the lights of the first wavelength and the second wavelength but not passing the light of the third wavelength, and a region 403 for passing only the light of the first wavelength but not passing the lights of the second and third wavelengths. The second aperture stop filter 109 is held with the objective lens holder 111 together with the objective lens and is also driven with the actuator 112. Thereby, the numerical apertures can be adjusted in accordance with a kind of optical disk for recording and reproducing operations.

Moreover, it is also allowable that the first aperture stop filter 101f and the second aperture stop filter 109 are adhered with each other, these filters are held with the objective lens holder 110 as illustrated in FIG. 3, and the filters are driven with the actuator 112 together with the objective lens.

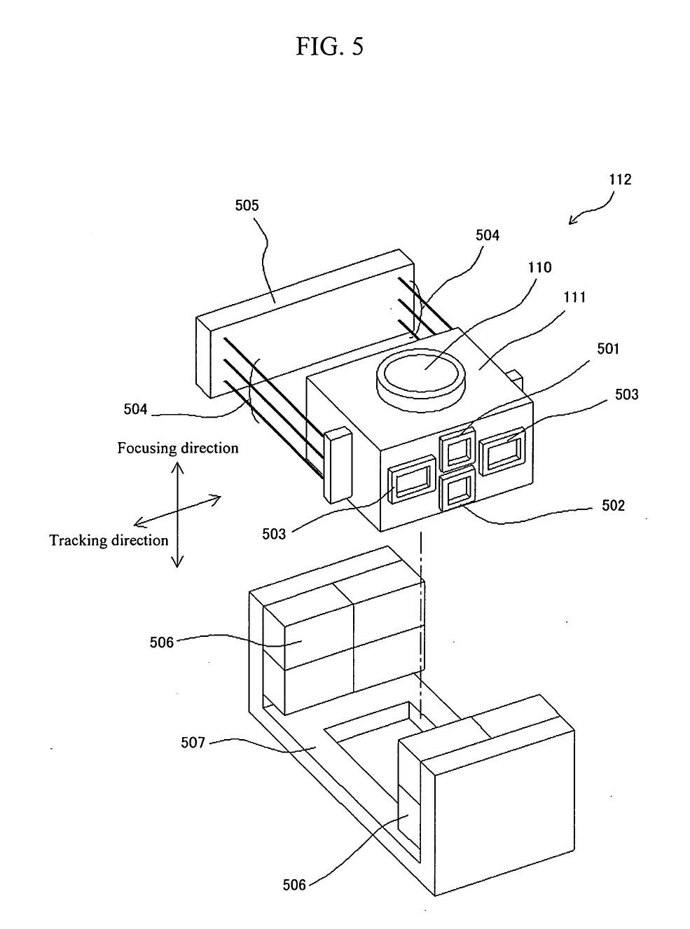

Structure of the actuator 112 is illustrated in FIG. 5. The actuator 112 is constituted with the objective lens 110, objective lens holder 111, a focusing coil 503 mounted to the objective lens holder 111, a first tracking coil 501 and a second tracking coil 502, a supporting member 504 for supporting the objective holder 111 to a fixing unit 505, a supporting member 504 for supporting the objective lens holder 111 to the fixing unit 505, a permanent magnet 506, and a yoke 507. A couple of focusing coils 503 are respectively allocated in a couple of side surfaces of the objective leans holder 111 provided in parallel in the tracking direction. A couple of first and second tracking coils 501, 502 are respectively allocated along the focus direction as the optical axis direction of the objective lens 110 at a couple of side surfaces of the objective lens holder 111 in parallel in the tracking direction. Here, the first tracking coil 501 is provided nearer to the objective lens 110 and the second tracking coil 502 is provided further from the objective lens 110.

The supporting member 504 is formed of a conductive elastic material and six supporting members 504 in total are provided for independently supplying the current to the focusing coil 503, first tracking coil 501 and the second tracking coil 502.

The permanent magnet 506 is magnetized in four poles opposing to the focusing coil 503, first tracking coil 501, and the second tracking coil 502. Otherwise, it is also possible to form the permanent magnet 506 by combining four single-pole permanent magnets in the manner to alternately show the magnetic poles.

Here, operations of the actuator 112 will be explained below. The servo circuit and actuator drive circuit generate the focus drive signal based on the focus error signal and then applies the drive current to the focusing coil 503 to drive the objective lens 110 in the focusing direction.

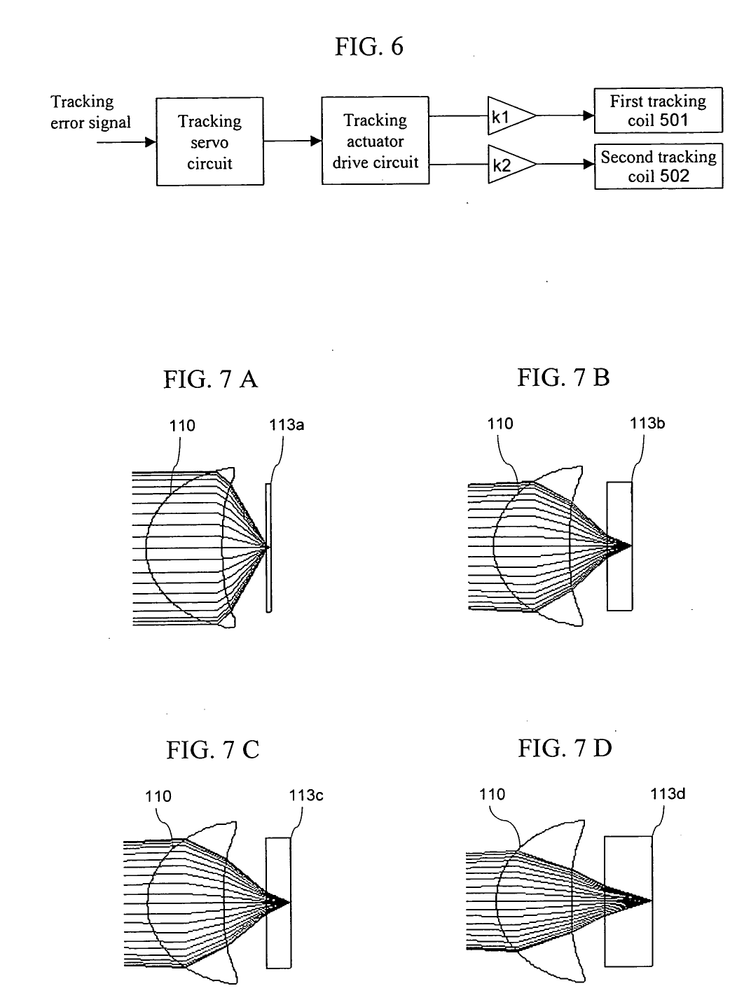

Next tracking drive and tilt drive will be explained with reference to FIG. 6. The servo circuit and actuator drive circuit generate the drive currents to the first and second tracking coils 501, 502 based on the tracking error signal. In this timing, the drive current to the first tracking coil 501 is multiplied with an amplifier up to k1 times, while the drive current to the second tracking coil 502 is multiplied with the amplifier up to k2 times and these multiplied drive currents are then impressed respectively to the tracking coils.

When k1 is equal to k2, the drive current to the first tracking coil 501 becomes equal to the drive current to the second tracking coil 502 and amplitudes of the drive forces generated in the first tracking coil 501 and the second tracking coil 502 become equal with each other.

When k1 is different from k2, for example, when k1 is larger than k2, the drive current to the first tracking coil 501 becomes larger than the drive current to the second tracking coil 502 and the drive force generated in the first tracking coil 501 becomes larger than that generated in the second tracking coil 502. Accordingly, the objective lens 110 can be tilted in the radial direction of the optical disk. In this timing, amount of lens tilt of the objective lens 110 is generated in accordance with a difference in the drive forces of the first and second tracking coils 501, 502. Here, since the drive current to the first and second tracking coils 501, 502 is proportional to amount of lens shift in the tracking direction, amount of lens tilt of the objective lens 110 can be generated in proportion to amount of lens shift in the tracking direction.

Accordingly, the objective lens 110 can be tilted in proportion to amount of lens shift in the tracking direction by setting the gain k1 and k2 of the amplifier to the predetermined values and moreover amount of lens tilt for amount of lens shift can be set desirably.

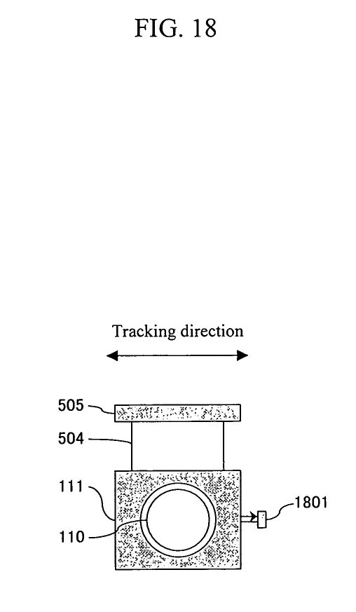

In FIG. 6, amount of lens tilt is determined on the basis of the tracking error signal, but amount of lens tilt may also be determined in accordance with amount of displacement by providing, for example, a means for detecting displacement of the objective lens in the tracking direction to the pickup device. The displacement detecting means is enough when a displacement sensor 1801 as illustrated in FIG. 18 is mounted to the lens holder or actuator.

In this embodiment, the parallel light is inputted to the first optical disk and the magnification of the objective lens is set to a negative value for the second, third, and fourth optical disks, namely the diverging light is inputted thereto. But, since the numerical apertures NA of the objective lens becomes large and comatic aberration due to objective lens shift increases rapidly when the absolute value of magnification is large in the finite type optical system, comatic aberration cannot be compensated sufficiently even when the lens is tilted. As indicated by the conditions (5) in this embodiment, NA of the objective lens for the second optical disk becomes largest in the finite type optical system. In the recording and reproducing of the second optical disk, in view of limiting the RMS wave front aberration when the comatic aberration is compensated with lens tilt under the objective lens shift of 0.3 mm to 0.07 λrms or less, the magnification β2 of the objective lens for the second optical disk is determined to satisfy the following conditions (1).
−0.080<β2<0 (1)

When the conditions (1) are satisfied, comatic aberration generated when the objective lens is shifted can be well controlled with lens tilt compensation even for the second optical disk having the large numerical apertures of the objective lens.

In this embodiment, the objective lens is tilted, in the finite type optical system, to compensate for comatic aberration generated when the objective lens is shifted. However, when amount of tilt required for compensation is large, an interval (working distance) between the objective lens and optical disk becomes small, resulting in possibility of collision between the objective lens and optical disk. Therefore, it is desirable that amount of tilt is as small as possible. When the curvature of the first surface of the objective lens is c1 and curvature of the second surface is c2, it is desirable that the following conditions (2) are satisfied.
c1>c2>0 (2)

For the following more concrete explanation, the first laser diode 101a is defined as the blue-violet laser diode in the wavelength λ1 of about 405 nm, the second laser diode 102a, as the red laser diode in the wavelength λ2 of about 660 nm, the third laser diode 103a, as the infrared laser diode in the wavelength of about 780 nm, the first optical disk 113a, as the BD, the second optical disk 113b, as HD DVD, the third optical disk 113c, as the DVD, and the fourth optical disk 113d, as the CD.

The first and second surfaces of the objective lens 110 has the non-spherical surface shape which can symmetrically rotate around the optical axis and this shape can be expressed with the following formula (3) under the conditions that height from the optical axis is r (unit: mm), distance in the optical axis direction from the contact plane at the top of surface of the non-spherical surface (amount of sag) is Z (unit: mm), curvature of the non-spherical surface on the optical axis is c (unit: 1/mm), circular cone constant is k, non-spherical surface coefficients of the 4^{th} degree, 6^{th} degree, 8^{th} degree, 10^{th} degree, 12^{th} degree, 14^{th} degree, 16^{th} degree, 18^{th} degree, and 20^{th} degree are respectively A, B, C, D, E, F, G, H, and J.

$$\begin{matrix}Z ( r ) = \frac{{cr}^{2}}{1 + \sqrt{1 - ( 1 + k ) {( cr )}^{2}}} + {Ar}^{4} + {Br}^{6} + \\ {Cr}^{8} + {Dr}^{10} + {Er}^{12} + {Fr}^{14} + {Gr}^{16} + {Hr}^{18} + {Jr}^{20}\end{matrix} \qquad ( 3 )$$

The curvature, conic coefficient, non-spherical surface coefficient of each degree, surface interval d of the first surface and second surface specifying the first surface and the second surface of the objective lens are indicated in the Table 1. The objective lens 110 is designed to compensate for the spherical surface aberration when the parallel light (magnification β1=0) is inputted to the objective lens in the first optical disk having the largest numerical aperture. The symbol E in the table 1 indicates the raised power wherein the cardinal number is 10 and the numeral in the right side of E is the index number.

TABLE 1

Shape of Surface

| | First surface | Second surface |
|---|---|---|
| Surface interval | | 1.90045 |
| Curvature c | 0.59900 | 0.05536 |
| Conic constant k | −0.385 | 0.05536 |
| 4^{th} degree coefficient A | 6.371260E-04 | 4.148289E-02 |
| 6^{th} degree coefficient B | 3.817124E-04 | −2.209576E-02 |
| 8^{th} degree coefficient C | −1.528716E-04 | 1.213583E-02 |
| 10^{th} degree coefficient D | 4.674044E-05 | −2.707741E-03 |
| 12^{th} degree coefficient E | 1.345470E-05 | 3.435235E-05 |
| 14^{th} degree coefficient F | 9.835218E-07 | −4.087786E-05 |
| 16^{th} degree coefficient G | −9.056940E-07 | 1.607150E-05 |
| 18^{th} degree coefficient H | −1.448842E-07 | 8.949911E-06 |
| 20^{th} degree coefficient J | 1.491536E-07 | −2.189424E-06 |

The typical numerical values of the optical system in this embodiment are indicated in the table 2. In the table 2, NA1, f1, λ1, t1, β1 are respectively the numerical apertures in the side of image, focal length, designed wavelength, substrate thickness of disk and magnification when the first optical disk is used, NA2, f2, λ1, t2, β2 are similar values when the second optical disk is used, NA3, f3, λ2, t3, β3 are similar values when the third optical disk is used, and NA4, f4, λ3, t4, β4 are similar values when the fourth optical disk is used. As explained above, the infinite type optical system (magnification β1=0) is provided for the first optical disk having the large numerical apertures and the magnification β2, β3, and β4 are determined to compensate for spherical aberration even when the second, third, and fourth optical disks are used. The RMS wave front aberration in the entire part of the optical system of the pickup in this embodiment has been 0.006 λrms, 0.005 λrms, 0.009 λrms and 0.004 λrms, respectively in the second, third, and fourth optical disks. Glass material of the objective lens is M-LAF81 and disk substrate is PC (Polycarbonate). The refractive indices at λ1, λ2, and λ3 are n405, n660, and n780, respectively, while vd is the Abbe's number in the d-line (587.6 nm).

TABLE 2

| | | | | |
|---|---|---|---|---|
| NA1 = 0.85 | f1 = 2.30 mm | λ1 = 405 nm | t1 = 0.1 mm | β1 = 0 |
| NA2 = 0.65 | f2 = 2.30 mm | λ1 = 405 nm | t2 = 0.6 mm | β2 = −1/14.19 |
| NA3 = 0.60 | f3 = 2.42 mm | λ2 = 660 nm | t3 = 0.6 mm | β3 = −1/13.43 |
| NA4 = 0.45 | f4 = 2.44 mm | λ3 = 780 nm | t4 = 1.2 mm | β4 = −1/8.3 |

| | n405 | n660 | n780 | νd |
|---|---|---|---|---|
| M-LAF81 | 1.762562 | 1.725172 | 1.718982 | 40.5 |
| PC | 1.622276 | 1.578642 | 1.578466 | 29.9 |

FIGS. 7A to 7D are light beam diagrams illustrating the objective lens 110 and the optical disks 113a, 113b, 113c, and 113d in this embodiment and also illustrating respective disks from the laser sources 101a, 102a, 103a when the recording and reproducing of signals are conducted in the respective optical disks.

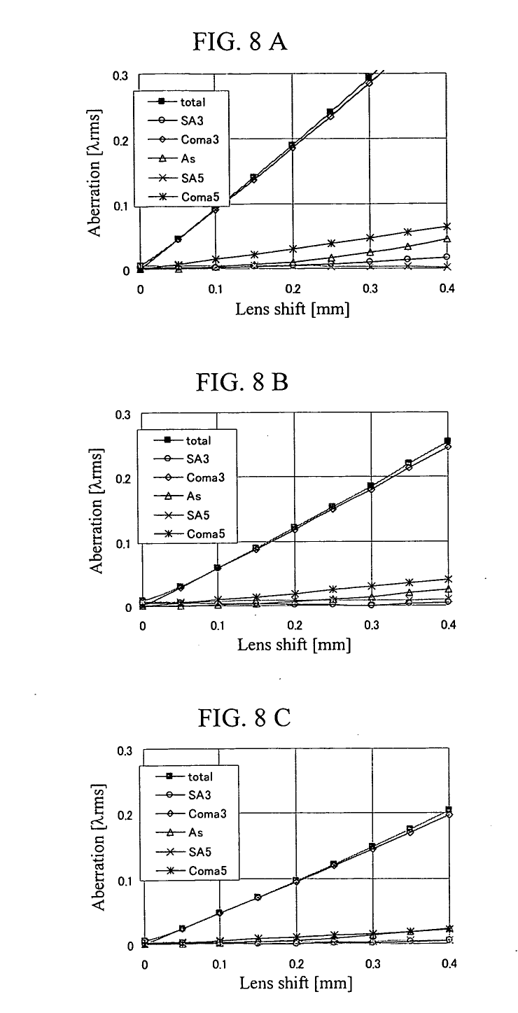

FIGS. 8A to 8C illustrate amount of wave front aberration generated for amount of lens shift when the objective lens 110 is shifted in the radial direction of optical disk in this embodiment. FIG. 8A illustrates amount of aberration in the second optical disk. FIG. 8B illustrates amount of aberration in the third optical disk. FIG. 8C illustrates amount of aberration in the fourth optical disk. The horizontal axis indicates amount of lens sift and the vertical axis indicates amount of various aberrations. In respective optical disks, comatic aberration is mainly generated together with lens shift. The RMS wave front aberrations of 0.2781 λrms, 0.176 λrms, 0.138 λrms in total are generated in the second, third, and fourth optical disks for the lens shift of 0.3 mm assumed in the half-height type optical pickup device, exceeding, to a large extent, the Marechal's criteria of 0.07 λrms as the diffraction limit performance and thereby excellent spot performance cannot be obtained. When the first optical disk is used, the plane wave is inputted to the objective lens because the focusing magnification β1 of the objective lens is equal to 0 (zero). In this case, comatic aberration is never generated even if the objective lens is shifted in the radial direction of the optical disk.

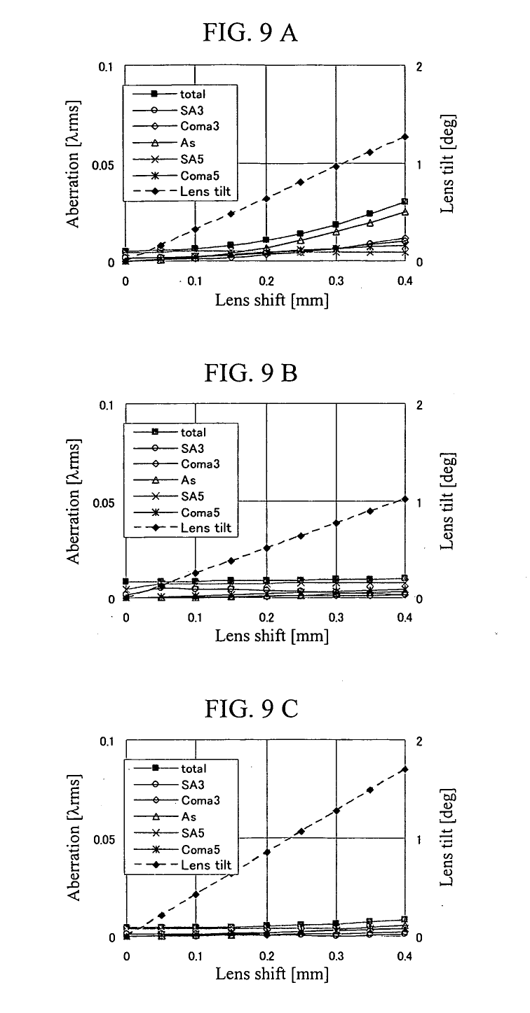

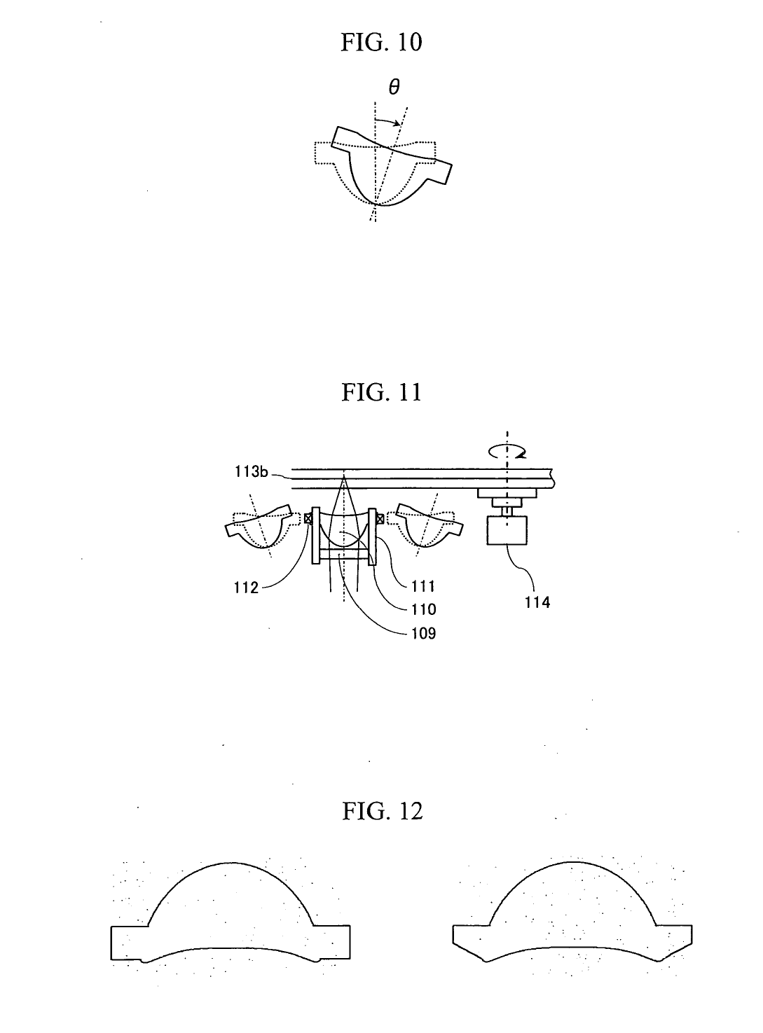

FIGS. 9A to 9C illustrate amount of wave front aberration for amount of lens shift in the case where the objective lens is tilted in the radial direction of optical disk due to the shift of objective lens required for compensation of comatic aberration generated when the objective lens 110 is shifted in the radial direction of optical disk as illustrated in FIGS. 8A to 8C of this embodiment. Like the FIGS. 7A to 7D, FIG. 9A illustrates amount of aberration in the second optical disk, while FIG. 9B, amount of aberration in the third optical disk and FIG. 9C, amount of aberration in the fourth optical disk, respectively. Amount of lens shift is graduated on the horizontal axis, while various aberrations on the left vertical axis and amount of lens tilt required for compensation on the right vertical axis. In FIGS. 9A to 9C, various aberrations are indicated with solid lines and amount of lens tilt with broken lines. Here, as illustrated in FIG. 10, amount of lens tilt is defined with a rotating angle θ when the objective lens rotates in the radial direction of optical disk around the top of the first surface of the objective lens 110. FIG. 11 schematically illustrates the profile in which the objective lens is tilted due to the shift of objective lens at the time of recording and reproducing operations of the second optical disk 113b. The objective lens illustrated with a dotted line in FIG. 11 indicates the condition where the lens only shifts in the radial direction of optical disk, while the lens illustrated with a solid line indicates the condition where the lens is further tilted for compensation of aberration in addition to lens shift. As illustrated in FIG. 11, in this embodiment, the first surface of the objective lens 110 is tilted facing to the optical axis side because of lens shift. As will be understood from FIG. 9, the RMS wave front aberration of the entire part of optical system when the objective lens 110 is shifted is almost not generated with inclusion of high order elements. For example, the RMS wave front aberration when the objective lens is shifted by 0.3 mm in the radial direction of optical disk is respectively 0.019 λrms, 0.009 λrms, and 0.006 λrms in the second, third, and fourth optical disks, these RMS wave front aberration values are equal to or less than 0.07 λrms, and thereby comatic aberration generated by lens shift can be well compensated. Namely, excellent spot performance can be obtained, even in the outside of the optical axis, for the first, second, third, and fourth optical disks. Moreover, the tilt angles of objective lens required for compensation of comatic aberration when the objective lens is shifted in 0.4 mm are 1.27°, 1.02°, 1.69° respectively in the second, third, and fourth optical disks. These values suggest that the tilt angle is reduced by about 15% in both DVD and CD in comparison with that required for compensation of aberration in JP-A No. 2004-14095 and that the tilt angle is reduced for the HD DVD from that in CD. The BD does not require tilting the objective lens because it is used in the finite type optical system (β1=0).

In the present invention, the objective lens is tilted in the radial direction of optical disk with shift of the same lens, but the edge thickness is not maintained to a constant value, for example, as illustrated in FIG. 12 and the external part of edge which is shifted toward the disk when the objective lens is tilted can also be formed thinner than the internal part of edge in order to prevent collision between the objective lens and optical disk when the interval between the objective lens and optical disk is reduced due to the lens tilt.

### Second Embodiment

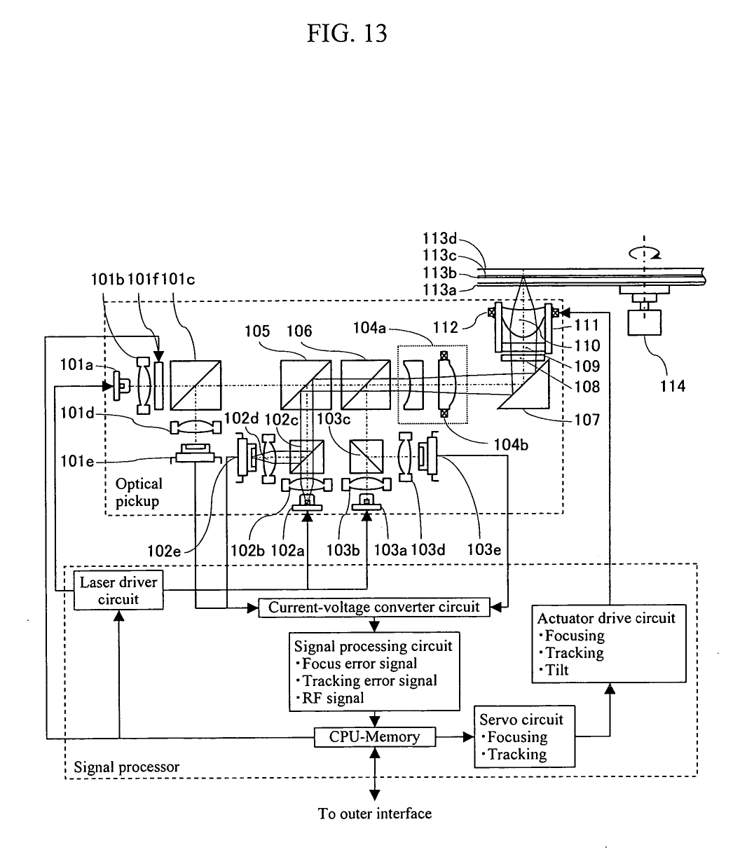

In the first embodiment, magnification is switched with the expander lens 104 when the first and second optical disks are recorded and reproduced. However, magnification of the objective lens can also be switched using the expander lens 104 for the first to fourth optical disks as illustrated in FIG. 13. In this structure, position of the coupling lens can be adjusted easily because the parallel light may be used as the light flux to be inputted to the expander lens from each laser source. Like the first embodiment, magnification may also be switched by using a liquid crystal element in place of the expander lens. Moreover, it is also allowed that the first aperture stop filter 101f is held with the objective lens holder 111 together with the objective lens 110 and is driven with the actuator 112 together with the objective lens. Moreover, it is also possible that the first aperture stop filter 101f and the second aperture stop filter 109 are adhered and are then held with the objective lens holder 110 and are then driven with the actuator 112 together with the objective lens. Each component illustrated in the accompanying drawings is denoted with the like reference numerals when it is similar to the like component in the first embodiment of the present invention.

### Third Embodiment

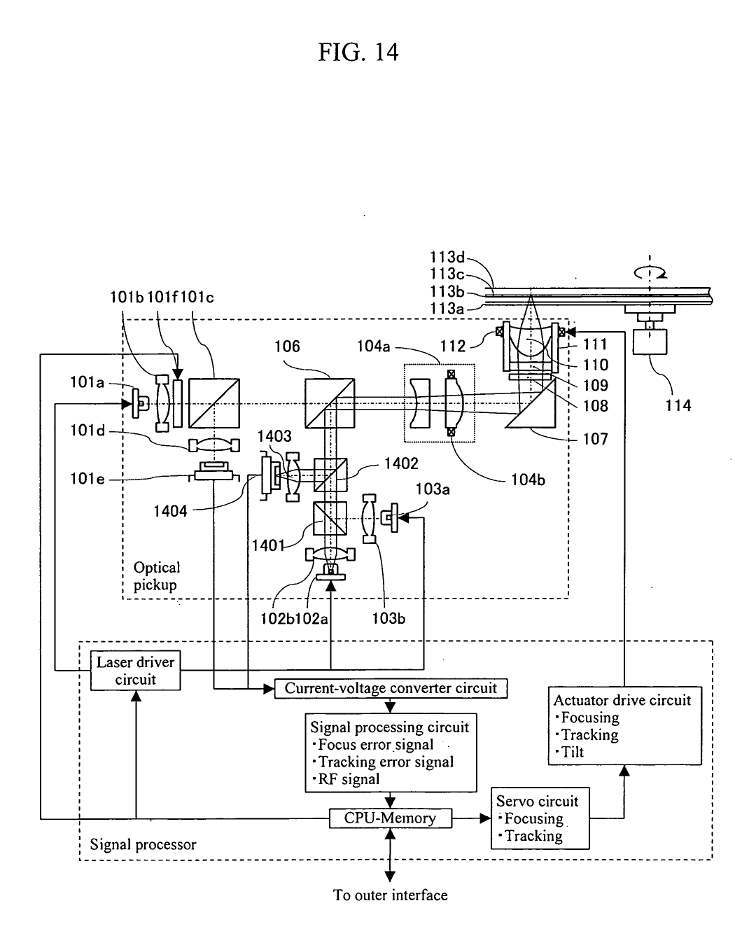

In the first and second embodiment, the detectors 102b, 103b are independently allocated but it is also possible to introduce the structure that the second detector 102b and the third detector 103b are used in common as illustrated in FIG. 14. The lights emitted from the second and third laser sources are combined with the light beam splitter 1401 and are condensed with the objective lens 110 to the optical disk 113c (optical disk of the DVD system) or 113d (optical disk of the CD system). The light reflected from an optical disk is reflected with the light beam splitter 1402 and is then condensed to the optical detector 1404 with the detecting lens 1403. Like the first embodiment, switching of magnification may be executed using a liquid crystal element in place of the expander lens. Moreover, the first aperture stop filter 101f may be held with the objective lens holder 111 together with the objective lens 110 and may also be driven with the actuator 112 together with the objective lens. In addition, the first aperture stop filter 101f and the second aperture stop filter 109 may be adhered with each other, may also be held with the objective lens holder 110, and may further be driven with the actuator 112 together with the objective lens.

### Fourth Embodiment

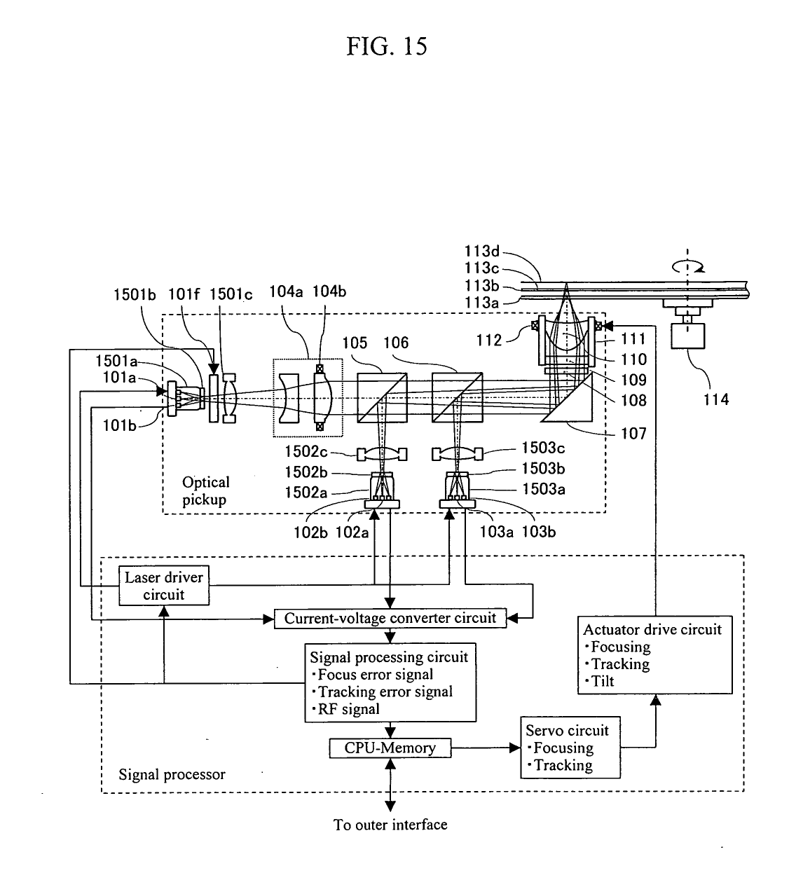

In the first to third embodiments, the laser diodes 101a, 102a, 103a and detectors 101b, 102b, 103b are allocated independently, but it is also possible to introduce a so-called laser module in which the semiconductor lasers and the detectors are accommodated in the same case. For example, in the embodiment illustrated in FIG. 15, the laser module is used, in which the first laser diode 101a and the first optical detector 101b are accommodated in the same case 1501a, while the second laser diode 102a and the second optical detector 102b are accommodated in the same case 1502a, and the third laser diode 103a and the third optical detector 103b are accommodated in the same case 1503a. 1501b denotes a hologram element having the function to isolate the light flux to one light flux emitted to the optical disk 113a or 113b from the first laser source 101a and another light flux reflected by the optical disk and then to guide the light flux on the returning optical path to the optical detector 101b. 1502b and 1503b also denote hologram elements having the like functions. 1501c, 1502c, 1503c denote coupling lenses. The expander lens also allows, like the first embodiment, replacement with a liquid crystal element or the like for switching of the magnification. Moreover, like the second embodiment, the magnification of objective lens can be switched using the expander lens 104 for the first to fourth optical disks. The first aperture stop filter 101f may be held with the objective lens holder 111 together with the objective lens 110 and may also be driven with the actuator 112 together with the objective lens. In addition, the first aperture stop filter 101f and the second aperture stop filter 109 may be adhered and may also be held with the objective lens holder 110 and moreover may be driven with the actuator 112 together with the objective lens.

### Fifth Embodiment

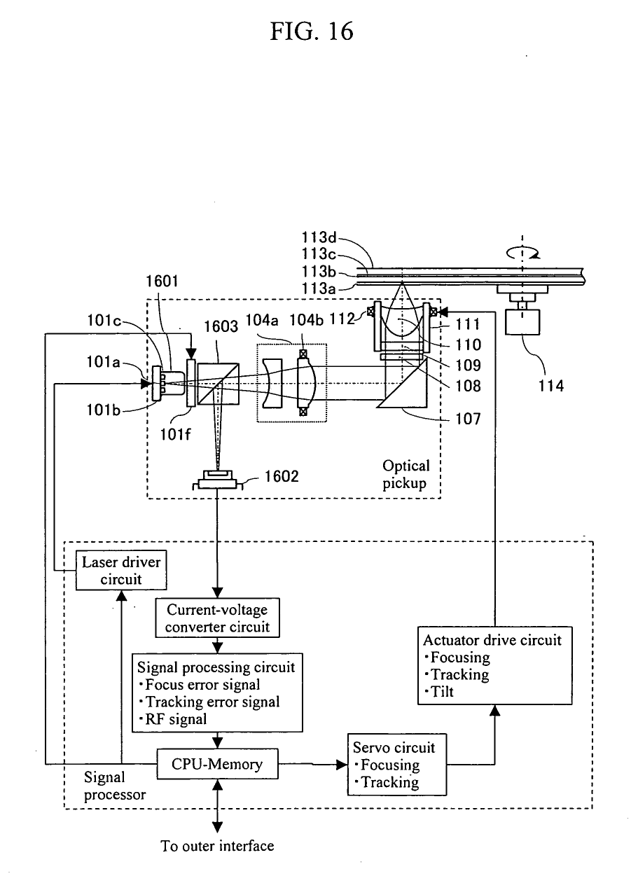

In the first to fourth embodiments, the laser diodes 101a, 102a, 103a are independently allocated, but these laser diodes may also be accommodated within the same case. For example, in the embodiment illustrated in FIG. 16, a three-wavelength laser 1601 integrating the first laser diode 101a, second laser diode 102a and the third laser diode 103a is used as the laser source and a common optical detector 1602 is used as the detecting system. 1603 denotes an optical beam splitter for splitting the light reflected from an optical disk from the optical path up to the optical disk from the laser source. Like the first embodiment, the expander lens allows replacement with a liquid crystal element for switching of the magnification. The first aperture stop filter 101f may be held with the objective lens holder 111 together with the objective lens 110 and may also be driven with the actuator 112 together with the objective lens. The first aperture stop filter 101f and the second aperture stop filter 109 may be adhered, may also be held with the objective lens holder 110, and may be driven with the actuator 112 together with the objective lens.

### Sixth Embodiment

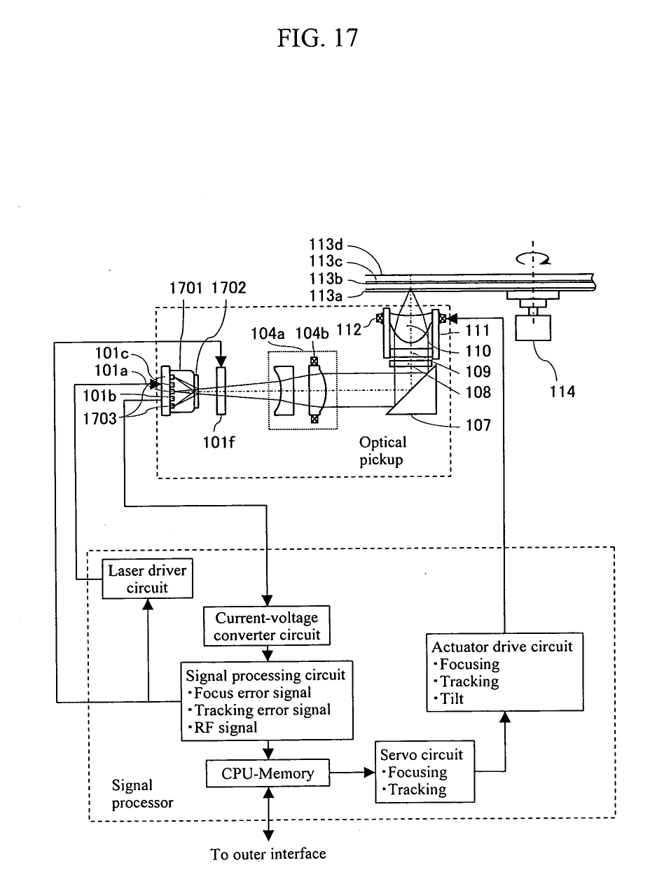

Furthermore, it is also possible to employ a laser module in which a plurality of laser diodes and a common optical detector are accommodated in the same case. For example, in the embodiment illustrated in FIG. 17, a laser module is used, in which the first, second, and third laser diodes 101a, 102a, 103a and an optical detector 1703 are accommodated within the same case 1701. 1702 denotes a hologram element having functions to isolate the light flux emitted toward the optical disks 113a, 113b, 113c, 113d from each laser source and the light flux reflected by the optical disk and guide the light flux on the returning optical path to the optical detector 1703. The expander lens allows, like the first embodiment, replacement with a liquid crystal element for switching of the magnification. The first aperture stop filter 101f may be held with the objective lens holder 111 together with the objective lens 110 and may also be driven with the actuator 112 together with the objective lens. The first aperture stop filter 101f and the second aperture stop filter 109 may be adhered and held with the objective lens holder 110, and may also be driven with the actuator 112 together with the objective lens.

As explained above, an optical pickup can be reduced in size by forming a unit in which the laser diode and optical detector are accommodated in the same case. Moreover, reliability of optical pickup can also be improved because adjustment of optical axis of each element becomes unnecessary.

The present invention enables simplification and integration of an optical pickup to be used in an optical information recording and reproducing apparatus. Moreover, the present invention can realize use of various types of optical disks such as the already standardized CD, DVD, BD, HD DVD with only one optical disk drive and only one optical pickup device.

What is claimed is:

1. An optical pickup device for recording and reproducing a first optical disk and a second optical disk of different types with the lights in almost identical wavelength, comprising an optical element for switching divergence or convergence of the light flux for said first optical disk and said second optical disk.

2. The optical pickup device according to claim 1, wherein said optical element is provided as an element for switching optical system to the infinite type optical system for said first optical disk and to the finite type optical system for said second optical disk.

3. An optical pickup device comprising:
a first laser source for radiating the light to a first optical disk having a first substrate thickness and to a second optical disk having a second substrate thickness which is different from said first substrate thickness,
an objective lens for condensing the light from said laser source to said first and second optical disks, and
an optical element for varying magnification of said objective lens in accordance with a kind of said first and second optical disks.

4. The optical pickup device according to claim 3, wherein said optical element functions as an element for switching optical system to the infinite type optical system for said first optical disk and to the finite type optical system for said second optical disk.

5. The optical pickup device according to claim 3, further comprising a tilt mechanism for tilting said objective lens in the radial direction of said first or second optical disk.

6. The optical pickup device according to claim 3, further comprising:
a second laser source for emitting the light which is different in wavelength from the light from said first laser source for radiating the light to a third optical disk which is different in the kind from said first and second optical disks, and
a third laser source for emitting the light which is different in wavelength from the lights from said first and second laser sources for radiating the light to a fourth optical disk which is different in the kind from said first, second, and third optical disks.

7. The optical pickup device according to claim 6, wherein
said objective lens is formed to provide the infinite type optical system for said first optical disk and the finite type optical system for said second, third, and fourth optical disks, and
said objective lens does not compensate for aberration due to lens tilt when said first optical disk is recorded or reproduced but compensates for aberration due to lens tilt when said second, third, and fourth optical disks are recorded or reproduced.

8. The optical pickup device according to claim 3, comprising:
an actuator for driving said objective lens in the radial direction of an optical disk,
wherein, amount of tilt of said objective lens is determined with an application current to a drive coil of said actuator.

9. The optical pickup device according to claim 3, comprising a lens position detector for detecting position of said objective lens,
wherein, amount of tilt of said objective lens is determined with amount of shift of said objective lens in the radial direction of said first or second optical disk detected with said lens position detector.

10. The optical pickup device according to claim 3, further comprising a first aperture stop element for limiting aperture to said second optical disk between said laser source and said objective lens.

11. The optical pickup device according to claim 6, wherein
wavelength of the light emitted from said first laser source is about 405 nm, wavelength of the light emitted from said second laser source is about 660 nm, and wavelength of the light emitted from said third laser source is about 780 nm,
said first optical disk is an optical disk of the BD system,
said second optical disk is an optical disk of the HD DVD system,
said third optical disk is an optical disk of the DVD system, and
said fourth optical disk is an optical disk of the CD system.

12. The optical pickup device according to claim 3, wherein said objective lens has the shape of non-spherical surface both in a first surface and a second surface, and the curvature c1 (unit: 1/mm) of the first surface and the curvature c2 (unit: 1/mm) of the second surface satisfy the following conditions (2).
c1>c2>0 (2)

13. The optical pickup device according to claim 3, wherein the first surface and the second surface of said objective lens has the symmetrical shape of non-spherical surface both in the first and second surfaces, and the first surface satisfies the following conditions (3)
0.55<c<0.65
0≦A,B<1.0E−3
−3.0E−4<C≦0
0≦D,E<1.0E−4
−2.0E−6<F,G,H,J<2.0E−6 (3)
and the second surface satisfies the following conditions (4)
0<c<0.1
0≦A<5.0E−2
−3.0E−2<B≦0
0≦C<2.0E−2
−3.0E−3<D≦0
0≦E<3.0E−4
−5.0E−5<F,G,H,J<5.0E−5. (4)
(where, c is curvature on the optical axis of the non-spherical surface, A to J are non-spherical surface coefficients of the even number degree up to 20^{th} degree from 4^{th} degree.)

14. The optical pickup device according to claim 3, wherein said objective lens is formed thinner in the external side of edge thickness, which gets close to a disk when the lens is tilted, than the internal side thereof.

15. The optical pickup device according to claim 6, wherein said optical element is formed to switch magnification for said first, second, third, and fourth optical disks.

16. The optical pickup device according to claim 6, wherein
the reflected light of the light from said second laser source and the reflected of the light from said third laser source are received with only one detector.

17. The optical pickup device according to claim 6, wherein
said first laser source and the first detector for receiving the reflected light of the light from said first laser source are accommodated in the same case,
said second laser source and the second detector for receiving the reflected light of the light from said second laser source are accommodated in the same case, and
said third laser source and the third detector for receiving the reflected light of the light from said third laser source are accommodated in the same case.

18. The optical pickup device according to claim 6, wherein said first, second, and third laser sources are accommodated in the same case.

19. The optical pickup device according to claim 6, wherein said first, second, and third laser sources and the optical detector for receiving the reflected light of the light from said first, second, and third laser sources are accommodated in the same case.

20. An optical pickup device for recording or reproducing of a first optical disk and a second optical disk in different substrate thickness using the lights of almost identical wavelength, characterized in comprising
an objective lens for condensing said light to said first and second optical disks, and
an optical element for switching divergence or convergence of the light flux of said light for said first optical disk and said second optical disk,
wherein the magnification β1 of said objective lens for said first optical disk is 0 (β1=0) and the magnification β2 of said objective lens for said second optical disk satisfies the following conditions (1),
−0.080<β2<0 (1)
